(19) United States
(12) Patent Application Publication
(10) Pub. No.: US 2016/0313053 A1
(43) Pub. Date: Oct. 27, 2016

(54) Illumination Apparatus Having An Optical Waveguide And Domestic Refrigeration Appliance Having Such An Illumination Apparatus

(71) Applicant: BSH HAUSGERÄTE GMBH, München (DE)

(72) Inventors: MAX EICHER, MUENCHEN (DE); PHILIPP KLEINLEIN, MUENCHEN (DE); BERND OSBAR, AALEN (DE); CHRISTIAN SCHMID, DIETENHEIM (DE); ARMIN WEBER, LAUCHHEIM (DE); ANDREAS DANLER, VOELS (AT); MANFRED GSTREIN, ABSAM (AT); GEORG SEEBACHER, VOELS (AT)

(21) Appl. No.: 15/103,953

(22) PCT Filed: Dec. 10, 2014
(86) PCT No.: PCT/EP2014/077261

§ 371 Date: Jun. 13, 2016

(30) Foreign Application Priority Data
Dec. 13, 2013 (DE) 10 2013 225 957.3

(51) Int. Cl. F25D 27/00; F25D 11/00; F21V 8/00; F25D 23/06

(52) U.S. Cl. CPC F25D 27/00; F25D 23/065; F25D 11/00; G02B 6/0038; G02B 6/004

(57) ABSTRACT

An illumination apparatus includes at least one illumination device and an elongated optical waveguide. The optical waveguide has a length, two ends, a back side and a front side opposite the back side. One of the two ends is optically coupled to the at least one illumination device, or each of the two ends is optically coupled to at least one illumination device. The back side of the optical waveguide has a coupling-out structure, which is an integral component of the back side of the optical waveguide and is configured to couple the light coupled into the optical waveguide out of the optical waveguide at least over a majority of the entire length of the optical waveguide through the front side of the optical waveguide. A domestic refrigeration appliance having such an illumination apparatus as an interior illumination apparatus is also provided.

The invention relates to an illumination apparatus having an optical waveguide and to a domestic refrigeration appliance having such an illumination apparatus, which is especially designed as a device for interior illumination.

US 2006/0083024 discloses an illumination apparatus having an optical waveguide and two illumination means, which couple their light into the end face sides of the optical waveguide. In order to achieve the most even light distribution possible within the optical waveguide a light-reflecting layer can be disposed on the optical waveguide.

DE 10 2010 031 696 A1 discloses a refrigerator and/or freezer device with two coolable interior spaces, which can be cooled to different temperatures. The interior space illumination is designed as a column of light, which extends over both of the coolable interior spaces. The column of light can comprise an optical waveguide and can run in or on a wall of the coolable interior spaces.

The object of the present invention is to specify a further illumination apparatus with an optical waveguide in which a light distribution within the optical waveguide that is as even as possible predominates and which is especially more easy to manufacture.

The object of the invention is achieved by an illumination apparatus having at least one means of illumination and an elongated optical waveguide, having a length, two ends, a back side and a front side lying opposite the back side, wherein one of the two ends is optically coupled to the at least one means of illumination or each of the two ends is optically coupled to at least one of the means of illumination, the back side of the optical waveguide has a coupling-out structure, which is an integral component of the back side of the optical waveguide and which is configured to couple the light coupled into the optical waveguide out of the optical waveguide at least over the majority of its entire length via its front side.

Accordingly the inventive illumination apparatus comprises the elongated optical waveguide. At one end of the optical waveguide or at both of its ends, i.e. at the end face sides, light of the one or more means of illumination is coupled into the illumination apparatus. The at least one means of illumination is preferably embodied as at least one LED. For a relatively good optical coupling the means of illumination or the LED preferably lies at the corresponding end or on the surface of the corresponding end of the optical waveguide or is touching it. Thus light is only coupled in at one end or possibly at both ends of the optical waveguide, so that preferably only a single LED is provided if light is only to be coupled into the optical waveguide at one of the two ends or preferably only a single LED per end is provided if light is to be coupled into the optical waveguide at both ends. This enables the number of means of illumination or LEDs to be reduced.

The optical waveguide is embodied elongated and can especially be embodied relatively small or thin. In particular the back side and the front side run between the two ends of the optical waveguide. The optical waveguide is preferably embodied in the form of a bar.

The light coupled into the optical waveguide is coupled out on its front side, i.e. along the optical waveguide. So that the illumination apparatus emits light as evenly as possible over the length of the optical waveguide, the back side of the waveguide lying opposite the front side is provided with the coupling-out structure, which makes sure that light is distributed as evenly as possible within the optical waveguide. In accordance with the invention this coupling-out structure is an integral component of the optical waveguide, i.e. is part of the optical waveguide. This enables the number of components needed for the inventive illumination apparatus to be reduced.

The inventive illumination apparatus is used for example to illuminate the interior of a domestic refrigeration appliance. A further aspect of the invention accordingly relates to a domestic refrigeration appliance having a heat-insulated body with an inner container, which delimits a coolable interior space intended for storage of foodstuffs, a refrigeration device for cooling the coolable interior space, a door leaf, which is intended to close off the interior space and to make it accessible when opened, and an illumination apparatus fastened to the interior space for illuminating the coolable interior space when the door leaf is opened, which is embodied as the inventive illumination apparatus.

The inventive domestic refrigeration appliance comprises the heat-insulated body with the inner container that delimits the coolable interior. This is cooled by means of the refrigeration device. This is preferably embodied as a refrigerant circuit known in principle to the person skilled in the art and is preferably designed so that it cools the coolable interior at least approximately to a predetermined temperature. The coolable interior is intended for storage of food.

The inventive domestic refrigeration appliance can be a domestic refrigerator for example. In this case the coolable interior is cooled to temperatures greater than 0° C. The inventive domestic refrigeration appliance can also be a domestic freezer. In this case the coolable interior is cooled to temperatures less than 0° C. The inventive domestic refrigeration appliance can also be a domestic fridge/freezer combination however. The inventive domestic refrigeration appliance can have precisely one coolable interior space, but can also have a number of coolable interior spaces, which can also be closed off and opened by a door leaf in each case. Each of the coolable interior spaces can have a separate inventive illumination apparatus as its interior illumination apparatus.

The inventive domestic refrigeration appliance can especially be designed such that the interior illumination only switches on when the door is opened, i.e. is switched off when the door leaf is closed. To this end the inventive domestic refrigeration appliance can have a door opening switch known in principle to the person skilled in the art.

The inventive domestic refrigeration appliance can also be embodied as a wine cooling cabinet, which is intended to store bottles filled with drinkable liquids, especially wine. In this case the door leaf is preferably at least partly transparent, in that it is made at least partly of glass. In this case in particular the interior illumination apparatus can illuminate the coolable interior even with the door leaf closed.

The interior illumination apparatus is especially fastened in a recess, preferably a pocket-shaped recess of the inner container. The inner container is preferably made of plastic. The recess can be manufactured by deep drawing.

The inner container can comprise two side walls, a roof and a rear wall. The interior illumination apparatus can be fastened to one of the two side walls of the inner container for example. It is also possible for a number of interior illumination apparatuss to be fastened to one of the two side walls. Both side walls can also be provided with at least one illumination apparatus. In addition or as an alternative, the rear wall and/or the roof can be provided with at least one illumination apparatus.

The pocket-shaped recess is preferably rectangular in shape and is especially embodied elongated. It especially extends in the vertical direction over at least a part of one of the side walls of the inner container.

Preferably, in accordance with a preferred variant of the inventive illumination apparatus, the coupling-out structure extends over the entire length of the optical waveguide on its back side. Thus, even in the areas of the two ends, a relatively even light distribution within the optical waveguide can be achieved.

In accordance with a preferred form of embodiment of the inventive illumination apparatus, the coupling-out structure is designed as channels or grooves formed into the back side of the optical waveguide. Because of the channels or grooves the reflection behavior of light within the optical waveguide is influenced, by which, through a suitable design of the channels or grooves, a distribution of light within the optical waveguide that is as even as possible is produced, scattering elements as a coupling-out structure are also conceivable. Channels and grooves are preferred however, since they can be formed into the back side relatively easily.

The channels or grooves or scattering elements are designed as pyramid shapes, cylindrical shapes or hemispherical shapes for example. The cylindrical-shaped grooves or scattering elements preferably have circular base surfaces.

The coupling-out structure, especially the channels or grooves or scattering elements, can be distributed in the same form along the length of the optical waveguide. Preferably however the depth of the channels or grooves and/or the density of the channels or grooves or scattering elements increases, the further away these are from the means of illumination or from the ends of the optical waveguide. The latter variant is advantageous with relatively long optical waveguides.

If for example the at least one means of illumination is only coupled optically at one of the two ends to said end, then, in accordance with a further preferred variant of the inventive illumination apparatus, the depth and/or the density of the channels or grooves or scattering elements increases as the distance from this end increases.

If however both ends of the optical waveguide are coupled to at least one of the means of illumination in each case, then in accordance with a further preferred variant of the inventive illumination apparatus, the depth and/or the density of the channels or grooves or scattering elements increases from the two ends in the direction of the center of the optical waveguide. In accordance with this variant of the inventive illumination apparatus the back side of the optical waveguide this has the deepest channels or grooves and/or the highest density of channels or grooves or scattering elements.

In accordance with a further preferred embodiment of the inventive illumination unit the front side of the optical waveguide is embodied as optics integrated into the optical waveguide in accordance with a desired emission characteristic of the illumination unit. This enables the emission characteristic of the inventive illumination unit to be adapted in a manner that is relatively simple and saves on components. As a result of the integration of the optics into an optical waveguide an additional component forming the optics of the illumination apparatus is also not required.

The optics can preferably be embodied as a convex curvature of the front side of the optical waveguide. Depending on the curvature, the angle of emission that is produced in relation to a plane is aligned at right angles to the back side, centrally in relation to the width and along the length of the optical waveguide, can be influenced. The curvature preferably runs evenly at least over a majority of the length of the optical waveguide, in order especially to obtain an even emission characteristic of the inventive illumination apparatus along the entire length, at least however over the majority of the entire length of the optical waveguide.

If for example the emission characteristic of the inventive illumination apparatus is to be designed such that the light emitted from the optical waveguide is to be emitted with the same angle of emission in relation to the aforementioned plane, then the curvature of the front side forming the optics is preferably embodied symmetrically relative to this plane.

In accordance with a form of embodiment of the inventive illumination apparatus, the curvature of the front side forming the optics is embodied asymmetrically relative to the plane that is aligned at right angles to the back side, centrally in relation to the width and along the length of the optical waveguide. This variant is a good idea when the emission characteristic of the inventive illumination apparatus embodied as interior illumination of the inventive domestic refrigeration appliance, which is fastened vertically to one of the side walls of the inner container, is to be designed so that the light shining from the optical waveguide where possible illuminates the entire coolable interior from the optical waveguide to the back wall of the inner container, but where possible not the inner container from the optical waveguide to the door leaf.

The optical waveguide especially includes two opposing side surfaces connecting the front side and the back side. In the case of the domestic refrigeration appliance the back side of the optical waveguide faces towards the recess or the inner container. The width of the recess corresponds especially to the width of the optical waveguide.

Preferably the recess is designed so that the optical waveguide, if it projects from the recess, only projects a relatively small distance with its front side.

The edges connecting the back side to the side surfaces are preferably rounded.

Preferably there can be provision for the transition areas between the front side and the side surfaces to be flush with the surface of the inner container or of its side wall aligned in the direction of the interior.

Depending on the form of embodiment of the inventive illumination apparatus or of the inventive domestic refrigeration appliance, an optical waveguide is produced with a coupling-out structure and preferably optics for illuminating especially a domestic refrigeration appliance, preferably a household refrigerator.

The light is coupled out via the coupling-out structure integrated into the back side of the optical waveguide, for example by means of extractors on the back side. The extractors are preferably arranged (density, size) so that the coupling-out is as even as possible over the length of the optical waveguide.

The domestic refrigeration appliance, especially embodied as a domestic refrigerator, can be illuminated relatively well, especially by a combined optical waveguide, which contains both coupling-out structure and optics. The light in this case is preferably created by LEDs, which couple into the end face sides of the optical waveguide. Through the use of a suitable structure of the back side of the optical waveguide, i.e. the coupling-out structure, the light is coupled-out forwards (front side) as evenly as possible over preferably the entire length of the optical waveguide. This light can then be distributed within the interior by means of the optics located on the front that are preferably present, in accordance with the requirements of the respective domestic refrigeration appliance.

The optical waveguide in this case can be embodied very small and can preferably be built into the inner container flush with its surface.

An exemplary embodiment of the invention is shown by way of example in the enclosed schematic drawings, in which:

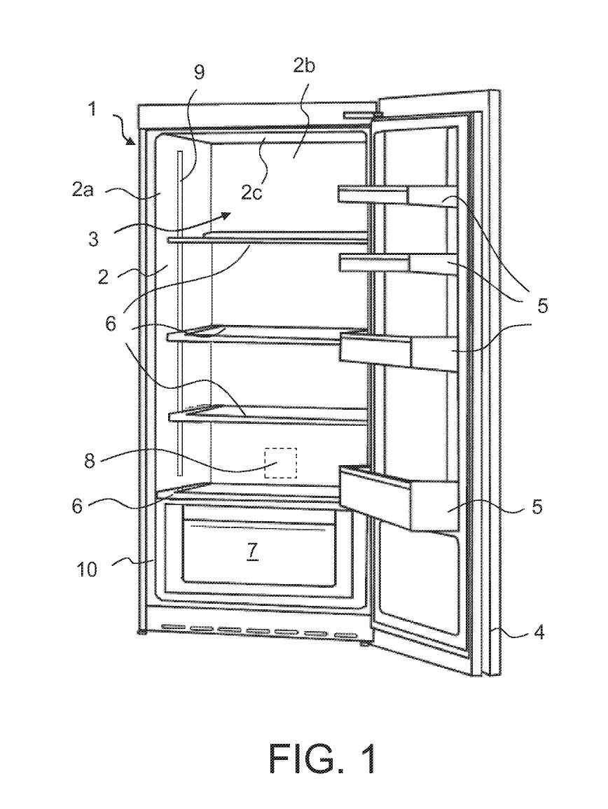

FIG. 1 shows a domestic refrigeration appliance with an inner container and an interior illumination apparatus fastened to the inner container, in a perspective diagram,

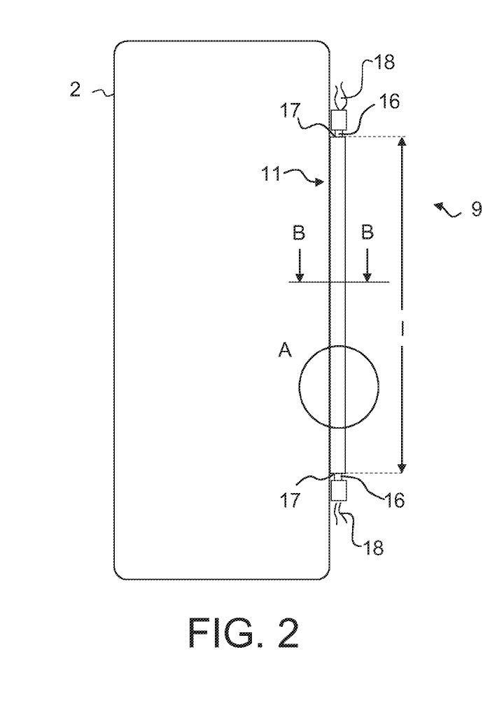

FIG. 2 shows a section of a front view of the inner container with the interior illumination apparatus fastened thereto,

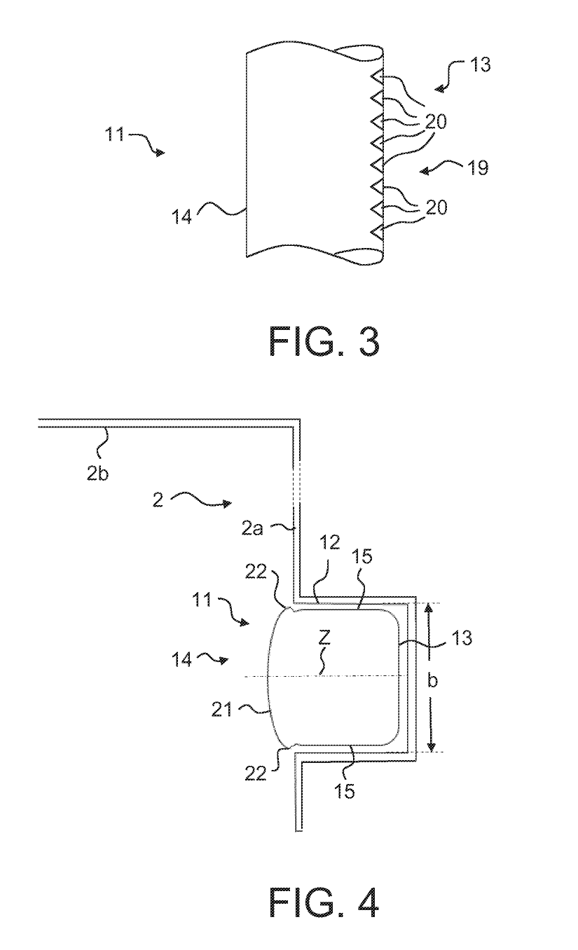

FIG. 3 shows a detailed view of a part of an optical waveguide of the interior illumination apparatus, and

FIG. 4 shows a section of the inner container and of the interior illumination apparatus of FIG. 2 along the line B-B.

FIG. 1 shows a perspective view of a domestic refrigeration appliance 1, having a thermally-insulated body 10 with an inner container 2, which delimits a coolable interior 3 intended for the storage of food. The inner container 2 comprises two side walls 2a lying opposite one another, a back wall 2b and a roof 2c.

In the case of the present exemplary embodiment the domestic refrigeration appliance 1 has a door leaf 4 for closing off the coolable interior 3 able to be pivoted in relation to an axis not shown in any greater detail running vertically.

When the door leaf 4 is open the coolable interior 3 is accessible. Arranged on the side of the door leaf 4 aligned in the direction of the coolable interior 3, in the case of the present exemplary embodiment, are a number of door shelves 5 for storage of food. Arranged in the coolable interior 3 are especially a number of shelves 6 for storage of food and in the lower area of the coolable interior 3 a drawer 7 is especially arranged, in which likewise food can be stored.

The domestic refrigeration appliance 1 includes a refrigeration device not shown in any greater detail, known in principle to the person skilled in the art, preferably in the form of a refrigerant circuit for cooling the coolable interior 3. The refrigerant circuit for example includes a compressor, a condenser downstream of the compressor, a choke device downstream of the condenser, which is especially designed as a choke or capillary tube, and an evaporator which is arranged between the choke device and the compressor.

The domestic refrigeration appliance 1 can be designed as a so-called no-frost domestic refrigeration appliance.

The domestic refrigeration appliance 1 can also be embodied as a wine cooler cabinet. In this case the food involved is preferable bottles filled with wine or with another drinkable liquid. The door leaf 4 in this case is at least partly transparent. It is at least partly made of glass for example. In this case there can be provision for there not to be any door shelves 5 arranged on the door leaf 4.

In the case of the present exemplary embodiment the domestic refrigeration appliance 1 includes a control device, which includes electronics for example and which is configured to control the refrigerating apparatus, especially the compressor of the refrigerant circuit, in the generally-known way, so that the coolable interior 3 has at least a predetermined or predeterminable target temperature. The control device 8 is preferably configured so that it regulates the temperature of the coolable interior 3. In order where necessary to maintain the actual temperature of the coolable interior 3, the domestic refrigeration appliance 1 can have at least one temperature sensor not shown in any greater detail and connected to the control device 8.

In the case of the present exemplary embodiment the domestic refrigeration appliance 1 includes at least one interior illumination apparatus 9, which is intended to illuminate the coolable interior 3, preferably only when the door leaf 4 is open. To this end the domestic refrigeration appliance 1 can include a door-opening switch not shown in any greater detail. If the domestic refrigeration appliance 1 is embodied as the wine cooling cabinet, then there can also be provision for the interior illumination apparatus 9 also to illuminate the coolable interior 3 when the door leaf 4 is closed.

In the case of the present exemplary embodiment the interior illumination apparatus 9 is fastened to one of the two side walls 2a of the inner container 2. It is also possible for a number of interior illumination apparatuss 9 to be fastened to one of the two side walls 2a. Both side walls 2a can also be provided with at least one illumination apparatus 9. In addition or as an alternative the back wall 2b and/or the roof 2c can also be provided with at least one illumination apparatus 9.

FIG. 2 shows a section of a front view of the inner container 2 with an internal illumination apparatus 9 fastened thereto.

In the case of the present exemplary embodiment the internal illumination apparatus 9 comprises an elongated, continuous or one-piece optical waveguide 11 of length I. A detailed view of a part of the optical waveguide 11 in area A is shown in FIG. 3 and FIG. 4 shows a section of the inner container 2 and the internal illumination apparatus 9 along the line B-B. In the example the internal illumination apparatus 9 is an illumination apparatus with one optical waveguide.

The optical waveguide 11 is fastened in or to the side wall 2a of the inner container 2 for example and preferably extends in the vertical direction. Preferably the optical waveguide 11 is fastened sunk into the corresponding wall of the inner container 2, especially in a recess 12 of the corresponding wall of the inner container 2. The recess 12 is especially designed in the shape of a pocket and is preferably made by deep drawing the inner container 2. The length of the recess 12 corresponds to the length I of the optical waveguide 11.

In the case of the present exemplary embodiment the optical waveguide 11 has a back side 13, a front side 14 and two opposite side surfaces 15 connecting the front side 14 and the back side 13. The back side 13 of the optical waveguide 11 faces towards the recess 12 or the inner container 2. The width of the recess 12 corresponds to the width b of the optical waveguide 11.

Preferably the recess 12 is designed so that the optical waveguide 11, if it projects at all from the recess 12, only projects a relatively small distance with its front side 14.

In the case of the present exemplary embodiment the edges connecting the back side 13 to the side surfaces 15 are rounded.

The interior illumination apparatus 9 comprises at least one means of illumination coupled optically to the optical waveguide 11, of which the light is coupled into the optical waveguide 11 when the interior illumination apparatus 9 is in operation. The means of illumination is preferably designed as at least one LED 16 or comprises at least the LED 16. The at least one LED 16 is preferably optically coupled to the optical waveguide 11 such that it touches said optical waveguide.

In the case of the present exemplary embodiment, there is provision for at least one means of illumination at both ends 17 of the waveguide 11, which means of illumination is embodied in each case as at least one LED 16 or comprises at least one LED 16. There may also, however, be provision for a means of illumination to only be provided at one of the two ends 17 of the waveguide 11, preferably in the form of at least one LED 16.

In the case of the present exemplary embodiment the means of illumination or the LEDs 16 are arranged within the side wall 2a, especially foam-molded into the side wall 2a. The means of illumination or the LEDs 16 are especially supplied with electrical energy by electric cables 18, preferably when the door leaf 4 is open. The electric cables 18 preferably run within the side wall 2a.

The optical waveguide, in the case of the present exemplary embodiment, is embodied such it couples out the light coupled in from the LED or LEDs 16 into the coolable interior with its side facing towards the coolable interior 3, i.e. its front side 14.

The optical waveguide 11 is designed such that the light coupled in from the LED or LEDs 16 is distributed as evenly as possible in the optical waveguide 11, in order to achieve a light emission through the front side 14 that is as even as possible over its length I.

In order to achieve this light distribution that is as even as possible over the length I of the optical waveguide 11 or to achieve this emission characteristic of the optical waveguide that is as even as possible along its length I, the back side of the optical waveguide 11 is structured or provided with a coupling-out structure 19 over the majority of its length I, which is an integral component of the optical waveguide 11. The coupling-out structure 19 can comprise a plurality of channels or grooves 20 and/or scattering elements, which are inserted into the back side 13 of the optical waveguide 11. The channels or the grooves 20 and/or the scattering elements are e.g. pyramid-shaped, cylinder-shaped, especially with a circular base surface, hemispherical-shaped etc. Because of the coupling-out structure 19 integrated into the back side 13, the light coupled into the optical waveguide 11 is coupled out as evenly as possible over the entire length 1 of the optical waveguide 11 on the front side 14 of the optical waveguide 11.

The coupling-out structure 20 can be arranged in the same shape along the length I of the optical waveguide 11. Preferably however the depth of the channels or grooves 20 and/or the density of the channels or grooves 20 and/or scattering elements increases, the further these are away from the LEDs 16. If at least one means of illumination, especially at least one LED 16 is provided at each of the two ends 17 of the optical waveguide 11, which couple their light into the optical waveguide 11, then for example the channels or grooves 20 in the center of the optical waveguide 11 have the greatest depth or density. If however only at least one means of illumination or at least one LED 16 is provided at one of the ends 17 of the optical waveguide 11, the depth and/or the density of the channels or grooves 20 increases as their distance from the at least one LED 16 or from the corresponding end of the optical waveguide 17 increases.

The front side 14 of the optical waveguide 11 is embodied as optics 21 integrated into the optical waveguide 11, in that the front side 14 of the optical waveguide 11 is formed in accordance with the desired emission characteristic of the interior illumination 9. The curvature of the front side 14 forming the optics 21 is especially embodied convex. Preferably the curvature of the front side 14 embodied as the optics 21 runs evenly over the entire length I, at least however over a majority of the length I of the optical waveguide 11.

Depending on the illumination of the coolable interior 3 desired, the curvature has a specific shape, so that the optics 21 is given a corresponding emission characteristic. If for example the emission characteristic of the interior illumination 9 is to be designed so that the light shining from the optical waveguide 11 is to shine with the same angle of radiation in the direction of the back wall 2b and in the direction of the door leaf 4, then the curvature of the front side 14 forming the optics 21 is embodied symmetrical relative to a plane Z, which is aligned at right angles to the back side 13, centrally in relation to the width b and along the length I of the optical waveguide 11. If on the other hand the emission characteristic of the interior illumination apparatus 9 is to be designed such that the light shining from the optical waveguide 11 is to illuminate the entire coolable interior 9 from the optical waveguide 11 to the back wall 2b of the inner container 2 where possible, but where possible not the inner container 2 from the optical waveguide 11 to the door leaf, then the curvature of the front side 14 forming the optics 21 is embodied asymmetrically relative to plane Z, which is aligned at right angles to the back side 13, centrally in relation to the width b and along the length I of the optical waveguide 11.

In the case of the present exemplary embodiment there is preferably provision for the transition areas 22 between the front side 14 and the side surfaces 15 to run flush with the surface of the inner container 2 aligned in the direction of the interior 3 or of its side wall 2a.

### LIST OF REFERENCE CHARACTERS

1 Domestic refrigeration appliance
2 Inner container
2a Side walls
2b Back wall
2c Roof
3 Coolable interior
4 Door leaf
5 Door shelf
6 Shelf
7 Drawer
8 Control device
9 Interior illumination apparatus
10 Body
11 Optical waveguide
12 Recess
13 Back side
14 Front side
15 Side surfaces
16 LED
17 Ends
18 Cables
19 Coupling-out structure
20 Channels or grooves
21 Optics
22 Transition areas
b Width
I Length
Z Plane

1-10. (canceled)

11. An illumination apparatus, comprising:
at least one illumination device; and
an elongated optical waveguide having a length, two ends, a back side and a front side disposed opposite said back side;
one of said two ends of said optical waveguide being optically coupled to said at least one illumination device or each of said two ends being optically coupled to at least one respective illumination device, for coupling light into said optical waveguide; and
a coupling-out structure being an integral component of said back side of said optical waveguide and being configured to couple the light coupled into said optical waveguide out of said optical waveguide through said front side at least over a majority of said length of said optical waveguide.

12. The illumination apparatus according to claim 11, wherein said coupling-out structure extends entirely over said length on said back side of said optical waveguide.

13. The illumination apparatus according to claim 11, wherein said coupling-out structure is constructed as at least one of channels, grooves or scattering elements introduced into said back side of said optical waveguide.

14. The illumination apparatus according to claim 13, wherein said at least one of channels, grooves or scattering elements have at least one of pyramid shapes, cylinder shapes or hemispherical shapes.

15. The illumination apparatus according to claim 14, wherein said cylinder shapes have a circular base surface.

16. The illumination apparatus according to claim 13, wherein said at least one illumination device is optically coupled to only one of said two ends of said optical waveguide, and said at least one of channels, grooves or scattering elements have at least one of a depth or a density increasing with an increasing distance from said one end.

17. The illumination apparatus according to claim 13, wherein said optical waveguide has a center, each of said two ends of said optical waveguide is optically coupled to at least one respective illumination device, and said at least one of channels, grooves or scattering elements have at least one of a depth or a density increasing with an increasing distance from said two ends towards said center of said optical waveguide.

18. The illumination apparatus according to claim 11, wherein said front side of said optical waveguide is constructed as optics being integrated into said optical waveguide in accordance with a desired emission characteristic of the illumination apparatus.

19. The illumination apparatus according to claim 18, wherein said optics are constructed as a convex curvature of said front side of said optical waveguide.

20. The illumination apparatus according to claim 19, wherein said convex curvature of said front side of said optical waveguide runs evenly at least over a majority of said length of said optical waveguide.

21. The illumination apparatus according to claim 19, wherein said optical waveguide has a width, and said curvature of said front side forming said optics is constructed asymmetrically relative to a plane being aligned at right angles to said back side centrally relative to said width and along said length of said optical waveguide.

22. A domestic refrigeration appliance, comprising:
a thermally-insulated body having an inner container delimiting a coolable interior intended for storage of food;
a refrigeration device for cooling said coolable interior;
a door leaf for closing off said coolable interior in a closed state and rendering said coolable interior accessible in an open state; and
an interior illumination apparatus according to claim 11 being fastened to said inner container for illuminating said coolable interior when said door leaf is in said open state.

23. The domestic refrigeration appliance according to claim 22, wherein said interior illumination apparatus is fastened in a recess of said inner container.
